(19) United States
(12) Patent Application Publication
(10) Pub. No.: US 2007/0136999 A1
(43) Pub. Date: Jun. 21, 2007

(54) STRUCTURE FOR BONDING HINGE FLAPS AND DOOR

(76) Inventor: Wen-Hsiu Huang, Chiayi City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/164,721

(22) Filed: Dec. 2, 2005

(51) Int. Cl. E05D 5/02

(52) U.S. Cl. 16/387

(57) ABSTRACT

The present invention relates to a structure for connecting the hinge flap and the door. More particularly, the outer side of the hinge flap in the door structure has a baffle side, and the inner side of the hinge flap has multiple baffle panels. Further, the baffle side and battle panel can form a lean guide side for the door. Besides, the upper and the lower of the hinge use the baffle side or the baffle panel in any sides of the hinge flap to lean on the door. Instead, the door is embedded into the middle of the baffle side and the baffle panel. Furthermore, two axes in the upper and the lower of two hinges for pivoting can be accurately positioned in the same centerline of the axis. It does not cause the occurrence of any incline. Moreover, the door can swing smoothly because the door is affixed with the door socket. Furthermore, the hinge also can have a long working life.

### CROSS-REFERENCES TO RELATED APPLICATIONS

Not Applicable

### STATEMENT REGARDING FEDERALLY SPONSORED RESEARCH OR DEVELOPMENT

Not Applicable

### FIELD OF THE INVENTION

Conventionally, the hinge structure comprises an axis (13) pivoted with two hinge flaps (11 and 12) as shown in FIG. 1 of the prior art. The two hinge flaps (11 and 12) can freely swing either for opening or closing. Moreover, both hinge flaps have several fixed holes (110 and 120). One (11) of the hinge flaps is fixed on the door socket, and the other hinge flap (12) is fixed on the door. Therefore, the door can be swung by the upper and lower hinge (11) which is fixed on the door socket.

In order to apply the hinge (1) to different sizes of doors, the hinge flaps (11 and 12) generally have the width as their largest dimension. When the hinge (1) is fixed on a thinner door (as shown in FIG. 2), it uses visual measurement to align the hinge flap center (12) and door center. Later, a screw is used to affix the hinge flap on the door. However, it cannot accurately make the alignment for the hinge flap center (12) and door center. Therefore, it causes the occurrence of an incline while the hinge is affixed on the door. Moreover, the upper and the lower axis (13) of the hinge (1) cannot position in the same center and also have difficulty enabling the door to correctly swing. Also, even if the inclined angle is small or cannot be recognized by visual measurement, a barrier still exists while the upper and lower hinge (1) swinging. After opening and closing the door for an extended period, the axis can easily become damaged and shorten the working life.

### SUMMARY OF THE INVENTION

In order to solve the above-mentioned problems, the present invention is to provide a technique related to the structure for connecting the hinge flap and the door and further forming a lean guide side for the door.

Moreover, the lean guide side of the structure for connecting the hinge flap and the door is positioned on the baffle side on the outside of the hinge flap.

The lean guide side of the hinge flap in the present invention is positioned on the baffle panel on the inside of the hinge flap.

According to the above descriptions for the present invention, the lean guide side on the hinge flap can use the lean guide side for the upper and the lower of the hinge on the door. Furthermore, two axes in the upper and the lower of two hinges for pivoting can be accurately positioned in the same centerline of the axis. It does not cause any inclined phenomenon. Moreover, the door can swing smoothly because the door is affixed with the door socket. Further, the hinge also can have a long working life.

### BRIEF DESCRIPTION OF THE DRAWINGS

The foregoing aspects, as well as many of the attendant advantages and features of this invention will become more apparent by reference to the following detailed description, when taken in conjunction with the accompanying drawings, wherein:

FIG. 1. is a 3-D diagram showing a hinge of the prior art;

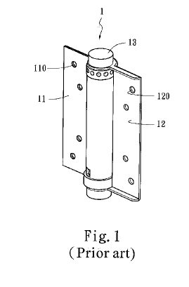

FIG. 2 is a prior art showing the hinge affixed on the door;

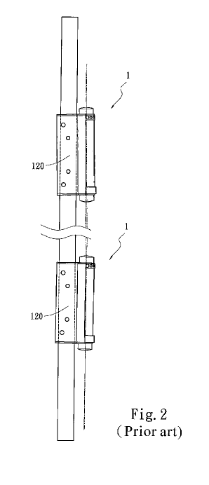

FIG. 3 shows one 3-D preferred embodiment of the present invention;

FIG. 4 is a diagram showing the hinge flap of the structure in the present invention affixed on the door; and

FIG. 5 is a cross-sectional view along A-A line referring to FIG. 4 in the present invention.

### DETAILING DESCRIPTION OF SOME EMBODIMENTS

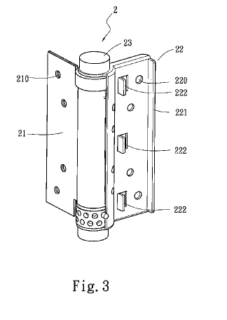

Please refer to FIG. 3. An axis (23) is pivoted with two hinge flaps (21 and 22) in the present invention for opening or closing between two hinge flaps (21 and 22). The hinge flaps (21 and 22) individually have the fixed holes (210 and 220). The outside of the hinge flap (22) for connecting the door has a baffle side (221). The corresponding hinge flap (22) of the baffle side (221) has a baffle panel (222) with a vertical arrangement. In other words, the baffle side (221) and baffle panel (222) can be the lean guide sides.

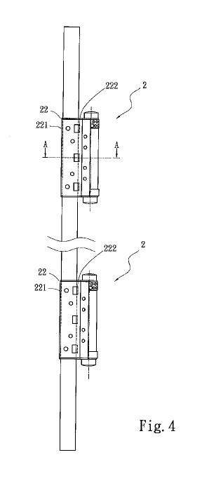

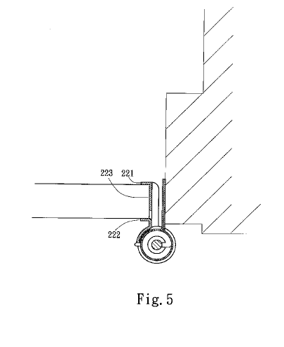

Please also refer to FIG. 4 and FIG. 5. Any baffle side (221) or baffle panel (222) in any side of the hinge flap (22) for leaning on the door, and the distance of the baffle side (221) and baffle panel (222) are same thickness. Therefore, the door is embedded into the middle of the baffle side (221) and baffle panel (222). Furthermore, the hinge flap (22) is screwed onto the door. Moreover, the baffle side (221) and baffle panel (222) of the hinge flap can be the reference for accurately positioning the upper and the lower axis (23) of the hinge (2) in the upper and the lower hinge (2) in the same centerline. Therefore, it does not cause any incline. Additionally, the door can swing smoothly. The resistance of the axis (23) during the door opening can be minimized as well thereby increasing the hinge's working life.

Furthermore, the two axes in the upper and the lower of the two hinges for pivoting can be accurately positioned in the same centerline of the axis. It does not cause any incline. Moreover, the door can swing smoothly because the door is affixed with the door socket. Furthermore, the hinge also can have a long working life.

What is claimed is:

1. A structure for connecting the hinge flap and the door comprising of:
Hinge including an axis between two hinge flaps for pivoting; wherein the hinge flap for connecting the door has a lean guide side for the door.

2. A structure for connecting the hinge flap and the door as cited in claim 1, wherein the lean guide side in the hinge flap can be formed from the baffle side in the outside of the hinge flap.

3. A structure for connecting the hinge flap and the door as cited in claim 1, wherein the lean guide side in the hinge flap can be formed from the baffle panel in the inside of the hinge flap.

4. A structure for connecting the hinge flap and the door as cited in claim 1, wherein the outside and the inside of the hinge flap individually have a baffle side and baffle panel for lean guiding of the door.

5. A structure for connecting the hinge flap and the door as cited in claim 4, wherein the distance of the baffle side and baffle panel is the same as the thickness of the door.
